(19) United States
(12) Patent Application Publication
(10) Pub. No.: US 2022/0187629 A1
(43) Pub. Date: Jun. 16, 2022

(54) Light Therapy for Relief of Pain

(71) Applicant: Duke University, Durham, NC (US)

(72) Inventors: Padma Gulur, Durham, NC (US); Amanda Nelli, Durham, NC (US)

(21) Appl. No.: 17/545,502

(22) Filed: Dec. 8, 2021

Related U.S. Application Data
(60) Provisional application No. 63/125,550, filed on Dec. 15, 2020.

(51) Int. Cl. G02C 7/10; G02C 7/04; G02C 7/02

(52) U.S. Cl. CPC G02C 7/104; G02C 7/04; G02C 2202/06; G02C 7/102; G02C 7/022

(57) ABSTRACT

The present disclosure describes a non-pharmacological analgesic approach using pain relieving effects of exposure to green-biased light spectrum. This green light effect is visually mediated and can be administered by exposing patients to the green-biased light spectrum by filtering ambient light. A therapeutic device is described in the form of green lensed eyeglasses and contact lenses that filter in the specific spectrum.

### RELATED APPLICATIONS

This application claims priority from U.S. Provisional Patent Application No. 63/125,550, filed Dec. 15, 2020, the disclosure of which is hereby incorporated by reference in its entirety.

### FEDERAL FUNDING LEGEND

This invention was made with Government support under Federal Grant No. RO3DA046011 awarded by the National Institutes of Health. The Federal Government has certain rights to this invention.

### BACKGROUND

The clinical use of opioid analgesics is a leading driver of the opioid misuse epidemic. Opioid exposures during clinical care are a key risk factor for subsequent misuse, and the probability of prolonged use scales with both dose and duration of opioid exposure. Minimizing opioid exposures reduces misuse risk. To do so while still effectively treating pain relies on opioid sparing multimodal analgesic strategies. That is, non-opioid analgesic adjuncts are added to opioid therapy, because no full replacement for opioids exists. In practice, this manifests as polypharmacy. Non-pharmacological options remain limited in efficacy or difficult to integrate into clinical care. Hence, there is an ongoing need for alternative pain treatment.

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

One aspect of the present disclosure provides a method of pain treatment, comprising, consisting of, or consisting essentially of exposing a subject to a green-biased light spectrum.

In some embodiments, the light spectrum is in the range of approximately 500-515 nm.

In some embodiments, the light spectrum is in the range of approximately 502-504 nm.

Another aspect of the present disclosure provides a device for treatment of pain in a subject, comprising, consisting of, or consisting essentially of a green-tinted lens.

In some embodiments, the lens is provided as eyeglasses or as a contact lenses.

In some embodiments, the green tinted lens provides a light spectrum in the range of approximately 500-515 nm, and optionally in the range of approximately 502-504 nm.

Some embodiments of the present invention are directed to a method of treatment of pain experienced by a subject. The method includes: filtering ambient light to expose the subject to a green-biased light spectrum having a peak transmission between 500 and 515 nm; and reducing pain in the subject in response to the filtering step.

In some embodiments, the green-biased light spectrum has a peak transmission between 502 and 506 nm. The peak transmission may be 40% or greater.

In some embodiments, the green-biased light spectrum has a peak transmission between 502 and 504 nm. The peak transmission may be 40% or greater.

In some embodiments, the peak transmission is 40% or greater.

In some embodiments, the green-biased light spectrum includes at least 25% transmission at each end wavelength in the green light wavelength band.

In some embodiments, the pain is caused by fibromyalgia.

In some embodiments, the pain is caused by thoracic surgery.

In some embodiments, the filtering step is carried out using eyeglasses worn by the subject. The method may further include wearing the eyeglasses for at least four hours per day for at least two consecutive weeks.

In some embodiments, the method further includes reducing anxiety in the subject in response to the filtering step.

Some other embodiments of the present invention are directed to a device for treatment of pain experienced by a subject. The device includes at least one lens configured to filter ambient light to expose the subject to a green-biased light spectrum having a peak transmission between 500 and 515 nm.

In some embodiments, the green-biased light spectrum has a peak transmission between 502 and 506 nm. The peak transmission may be 40% or greater.

In some embodiments, the green-biased light spectrum has a peak transmission between 502 and 504 nm. The peak transmission may be 40% or greater.

In some embodiments, the green-biased light spectrum includes at least 25% transmission at each end wavelength in the green light wavelength band.

In some embodiments, the device includes: a frame holding the at least one lens and configured to be worn over the ears and nose of the subject such that the at least one lens is positioned in front of the eyes of the subject; a first extension extending rearwardly from a first edge of the at least one lens and configured to extend toward a first ear of the subject; and a second extension extending rearwardly from a second opposite edge of the at least one lens and configured to extend toward a second ear of the subject. The first and second extensions may be configured to block ambient light from reaching the eyes of the subject.

In some embodiments, the first and second extensions are also configured to filter ambient light to expose the subject to a green-biased light spectrum having a peak transmission between 500 and 515 nm (or between 502 and 506 nm or between 502 and 504 nm).

### BRIEF DESCRIPTION OF THE DRAWINGS

The accompanying Figures and Examples are provided by way of illustration and not by way of limitation. The foregoing aspects and other features of the disclosure are explained in the following description, taken in connection with the accompanying example figures (also “FIG.”) relating to one or more embodiments.

FIG. 1 is a perspective view of eyeglasses for treatment of pain according to some embodiments of the present invention.

FIG. 2 is a chart illustrating transmission of eyeglasses used in a first trial study.

FIG. 3 is another chart illustrating transmission of eyeglasses used in the first trial study.

FIG. 4A is a front view of eyeglasses used in the first trial study.

FIG. 4B is a side view of the eyeglasses of FIG. 4A.

FIG. 5 is a chart illustrating percent transmission of eyeglasses used in a second trial study.

FIG. 6 is a chart illustrating the rate of a 10% or greater decline in oral morphine equivalents (OME) for the second trial study.

FIG. 7 is a chart illustrating the decline of anxiety score for the second trial study.

### DETAILED DESCRIPTION

For the purposes of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e. at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).

As used herein, the transitional phrase “consisting essentially of” (and grammatical variants) is to be interpreted as encompassing the recited materials or steps “and those that do not materially affect the basic and novel characteristic(s)” of the claimed invention. Thus, the term “consisting essentially of” as used herein should not be interpreted as equivalent to “comprising.”

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

As used herein, “treatment,” “therapy” and/or “therapy regimen” refer to the clinical intervention made in response to a disease, disorder or physiological condition manifested by a patient or to which a patient may be susceptible. The aim of treatment includes the alleviation or prevention of symptoms, slowing or stopping the progression or worsening of a disease, disorder, or condition and/or the remission of the disease, disorder or condition.

The term “effective amount” or “therapeutically effective amount” refers to an amount sufficient to effect beneficial or desirable biological and/or clinical results.

As used herein, the term “subject” and “patient” are used interchangeably herein and can refer to both human and nonhuman animals. In some embodiments, the subject comprises a human who is undergoing pain therapy with a method and/or device as prescribed herein.

Unless otherwise defined, all technical terms used herein have the same meaning as commonly understood by one of ordinary skill in the art to which this disclosure belongs.

Over the past 20 years, the use of opioid analgesics to treat pain has increased dramatically. However, it has also become clear that opioid use has a high risk of misuse, abuse, and addiction. At the same time, the treatment of pain is an essential part of clinical care and often remains insufficient despite being an ongoing source of human suffering. Stakeholders at all levels recognize that pain management is a crucial component of addressing the opioid epidemic, as well as overall health.

The present disclosure addresses these and other concerns by providing a novel, non-pharmacological analgesic approach to pain treatment, based upon preclinical findings of pain relieving effects of exposure to green-biased light spectrum. The green light effect is visually mediated, and the specific green-biased light spectrum can be obtained by filtering ambient light.

Recent preclinical findings have demonstrated robust antinociception in response to green light. These effects occurred both through the addition of green (525 nm) illuminating light and through green-biased filtration of visualized ambient light via contact lenses. Further, the effects persisted beyond the period of green light exposure. Essentially, seeing a green-biased light spectrum caused an ongoing reduction in pain responses (discussed further in the Examples section hereinbelow). This green light effect is novel in terms of pain, but it has precedents in the well-recognized effects of visualized blue light and full-spectrum light on circadian rhythms and mood/affect.

One aspect of the present disclosure provides lenses that are tinted green to a specific color spectrum, in order to treat specific conditions. In some embodiments, the lenses are provided as contact lenses or as a pair of eyeglasses (or simply, “eyeglasses”).

As disclosed herein, the color “green” is defined as light spectrum wavelengths of approximately 480-580 nm. In particular, the present disclosure describes that there are therapeutic effects using green light transmission (or peak transmission) between 500-515 nm. For some illnesses and/or conditions, light wavelengths (or peak transmission) of 502-506 nm or 502-504 nm provide the most benefit for patients in pain.

Another aspect of the present disclosure provides a method for treating both acute and chronic pain conditions using a specific wavelength of green light. In some embodiments, the green light is used as an analgesic adjunct to opioid therapy.

In some embodiments, a method of treatment of pain experienced by a subject includes filtering ambient light to expose the subject to a green-biased light spectrum having a peak transmission between 500 and 515 nm. In some embodiments, the peak transmission is between 502 and 506 nm and, in some other embodiments, the peak transmission is between 502 and 504 nm.

In some embodiments, the filtering is such that the green-biased light spectrum includes at least 25% transmission at each end (lower and upper) wavelength in the green light wavelength band. Thus, if the green light band extends from 480 nm to 580 nm, the green-biased light spectrum includes at least 25% transmission at these wavelengths according to some embodiments.

In an example embodiment, green-tinted glasses as disclosed herein are given to a subject with an acute and/or chronic pain condition. The subject wears glasses for at least four hours a day in ambient light. In the case of acute pain (e.g., after a surgical operation), a patient can be provided with the glasses on the same day that the surgery is conducted. Similarly in the case of chronic pain, the subject wears the glasses every day for at least four hours.

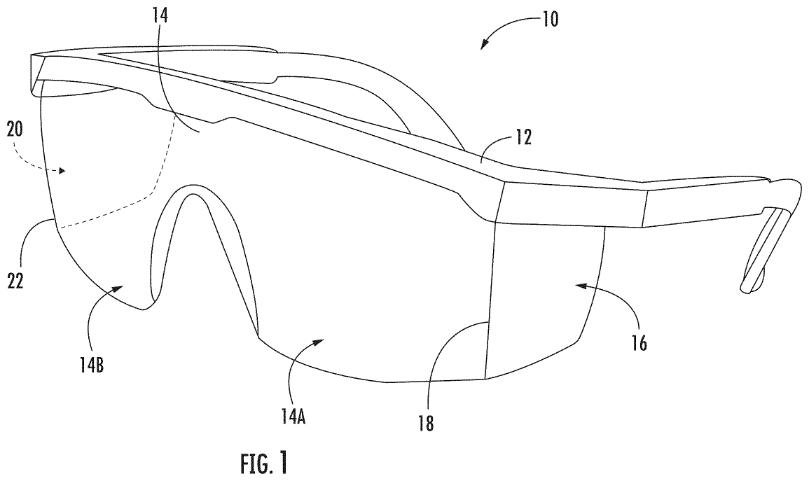

Example eyeglasses 10 are illustrated in FIG. 1. The eyeglasses 10 include a frame 12 and at least one lens 14 held by the frame 12. The frame 12 is configured to be worn over the ears and nose of a subject such that the at least one lens 14 is positioned in front of the eyes of the subject. In some embodiments, the at least one lens 14 includes first and second lenses 14A, 14B. The at least one lens 14 may be configured to filter ambient light to expose the subject to a green-biased light spectrum having a peak transmission between 500 and 515 nm, between 502 and 506 nm, or between 502 and 504 nm in various embodiments.

In some embodiments, a first extension 16 extends rearwardly from a first edge 18 of the at least one lens 14 (or from the first lens 14A) and a second extension 20 extends rearwardly from a second edge 22 of the at least one lens 14 (or from the second lens 14B). The first and second extensions 16, 20 are configured to block or prevent ambient light from reaching the eyes of the subject (with such ambient light affecting the optical performance of the eyeglasses). In some embodiments, like the at least one lens 14, the first and second extensions 16, 20 are also configured to filter ambient light to expose the subject to a green-biased light spectrum having the target peak transmission.

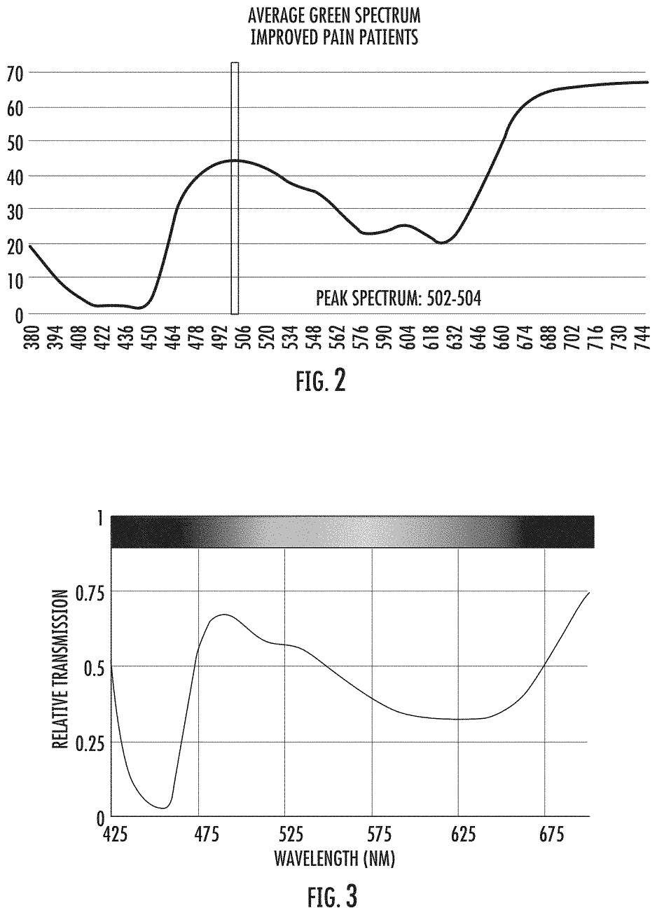

In an example embodiment to demonstrate the effectiveness, patients scheduled for thoracic surgery with anticipated post-operative opioid treatment (i.e., acute surgical pain) were enrolled in the trial. The subjects were randomized to groups of clear eyeglasses (control) or green eyeglasses, and a third group was given blue eyeglasses (blue wavelength of light 435-480 nm). It was found that blue eyeglasses did not help with analgesia in this population, while green eyeglasses were of benefit. Table 1 and FIG. 2 depict the results of the study. The results of blue light were similar to clear light.

TABLE 1

| | | Clear | Green |
|---|---|---|---|
| First Pain Score | Average | 3.7 | 4.6 |
| | Median | 4 | 5 |
| Last Pain Score | Average | 2.4 | 1.8 |
| | Median | 2.5 | 0 |
| Change in Pain | Average | −1.3 | −2.8 |
| Score | Median | −1.5 | −5 |

As can be seen in FIG. 2, green light transmission between 500-515 nm with a peak at 502-504 provided the most benefit for patients in pain.

One advantage of the disclosed lenses is that they will likely be well-tolerated and will not interfere with other aspects of clinical care, and thus patients are likely to be compliant with their use and care providers to be accepting of their use.

Further details of the disclosure are described in the Examples hereinbelow.

The following Examples are provided by way of illustration and not by way of limitation.

### Example 1: Research Strategy

### 1. Significance

### 1.1 Scientific Premise

Over the past 20 years, the use of opioid analgesics to treat pain has increased dramatically. Among the drivers of this trend have been a greater recognition of the need to seriously address pain and an underestimation of the adverse effects of opioids16. Between 1999 and 2008 alone, prescription opioid overdose death rates, treatment admission rates, and prescription opioid sales increased 400%. A vast body of lay reporting and academic research, including our own, has explored and detailed the risks of opioid therapy. Of chief public concern is the risk of misuse, abuse, and addiction. There is now an opioid misuse epidemic. Drug overdoses are the leading cause of accidental death in the United States, having surpassed automotive collision fatalities for the first time. The majority of these deaths involve opioids, and 12 million Americans reported misusing opioids in 2015. Combatting the opioid misuse epidemic is an urgent national priority. As the clinical use of opioids has been a leading driver of the misuse epidemic, considerable emphasis has been placed upon reforming such use as a key strategy in the prevention of opioid abuse. At the same time, the treatment of pain is an essential part of clinical care and often remains insufficient despite being an ongoing source of human suffering. Stakeholders at all levels recognize that ensuring that pain is well-managed is a crucial component of addressing the opioid epidemic.

Unfortunately, opioid analgesics remain indispensable tools for the treatment of pain. For many pain states, there is no complete replacement. As such, reforms to the clinical use of opioids have emphasized strategies to minimize opioid exposures. This includes both the elimination of unnecessary exposure and the addition of non-opioid analgesics to opioid therapy as opioid sparing analgesic adjuncts. This is commonly termed opioid sparing multimodal analgesia. This can often be limited in real-world impact because of the limited efficacy of available analgesic adjuncts and the challenging toxicology of polypharmacy. Non-pharmacological strategies are limited in efficacy or applicability, can be difficult to integrate into existing clinical care, and can have issues with patient acceptability and compliance. A broadly-effective and easily-adoptable nonpharmacological analgesic approach would be of considerable value.

One potential strategy was recently described by Ibrahim and colleagues, who conducted an extensive preclinical characterization of antinociception induced by green light. The authors report that exposure to green light produced robust and sustained antinociception in animal models of both acute and chronic pain.

Interestingly, the authors went on to demonstrate that the effects of green light therapy were visually mediated and could be induced either by the addition of green light or by the green-biased filtration of ambient light (via green contact lenses). This is conceptually similar to the bright light therapy which has proven surprisingly effective in the clinical treatment of mood/affect disorders. In this case, Ibrahim and colleagues go on to provide convincing evidence that green light therapy produces a true antinociceptive effect (rather than a stress effect or motor deficit) and that this effect involves the modulation of descending pain control mechanisms resulting in signaling and proteasome changes at the spinal cord level. The authors make a strong case that green light visualization alters pain processing both centrally and peripherally.

There is some precedence for visually-mediated light effects on pain perception. Leichtfried and colleagues report improvements in pain and depression among patients with chronic back pain when treated with bright light therapy. However, this study demonstrated a greater effect on depression than on pain and was conducted with patients suffering from both. As bright light therapy is an effective treatment of depression, interpretations of these results are unavoidably confounded. More applicably, Noseda and colleagues examined color differences in migraine photophobia and report that green light is less exacerbating to migraine headaches than other colors and, at low intensity, actually reduced headache severity. The findings would appear to show the presence of a pain-relieving effect of green light in humans.

Because of the nature of mammalian visual perception, both the addition of green light and the green-biased filtration of ambient light result in the visualization of a green-biased color spectrum. Therefore, it is not surprising that this effect could be elicited by both addition and filtration. There are clear parallels between the reported effects of green light visualization on pain perception and the effects of blue light visualization on circadian rhythm and arousal. While initially both concepts seem nonsensical, the latter is now well-recognized and widely exploited.

Given this context and the strong preclinical work by Ibrahim and colleagues, the natural question becomes whether the pain-relieving effects of a green light therapy are present when translated into clinical use.

We propose to test such a translation using an eyeglasses-based approach. This is particularly promising because it offers a low-burden implementation that is easy to use and broadly compatibility with existing clinical care. Similar visual spectrum manipulations also show excellent tolerability: bright light therapy is now even being explicitly trialed in pregnant women and juveniles. Because of this compatibility, we specifically aim to test the usefulness of green light therapy as an opioid sparing analgesic adjunct.

### 1.2 Significance of the Expected Research Contribution

First, this application is significant because it will directly address the major limitation of opioid-sparing multimodal analgesia: the lack of effective and broadly useful analgesic adjuncts. While a bevy of such adjunct treatments exist, their usefulness is often limited, as described above. Opioid sparing multimodal analgesia is, in concept, an essential component in reducing the clinical opioid exposures underpinning the opioid misuse epidemic. However, in practice, actual implementation is hampered by the limitations of current modalities. There is a critical need for opioid-sparing strategies with more real-world utility and broader applicability. This proposal aims to develop exactly that.

Second, the proposal is innovative because we will investigate, for the first time, the clinical effectiveness of green light therapy as an analgesic strategy. Further, we have chosen a model of green light therapy using low-cost, commercially-sourced eyeglasses. This is intended to maximize real-world applicability by emphasizing simplicity, compatibility with other treatment modalities and normal clinical care, tolerability for patients.

Third, we will use a systematic approach to assess the clinical utility of eyeglasses-based green light therapy, beginning with this pilot trial. The work proposed here will provide the practical grounding and outcomes data estimates which will be essential in the design of an effective, definitive trial. This pilot trial will assess all aspects of trial conduct and obtain subjective feedback from participants and providers to optimize both the treatment and the definitive trial.

### 2. Innovation

The proposed eyeglasses-based green light therapy is novel in clinical use. The central feature of this approach is use of a low-cost, minimally-interfering, maximally tolerable method (eyeglasses) to allow the broad delivery of a promising new non-pharmacological analgesic therapy. The use of such therapy is unique in regard to both the treatment of pain and as a strategy for reducing opioid exposures in clinical care. Eyeglasses-based green light therapy is a substantial departure from the status quo in 3 important ways:
1. Currently, the modification of visualized light spectrum has not been used clinically for the treatment of pain. Indeed, such an intentional effect has only been recently reported in preclinical models for the first time. It remains to be determined whether the effect translates into human populations. This proposal aims to do exactly that. This is the first effort we are aware of to test the efficacy of green light therapy as an integrated component of multimodal analgesia in a clinical setting.
2. This study is explicitly designed to test the usefulness of green light therapy in reducing clinical opioid exposures, which are a key driver of opioid misuse. As discussed above, the lack of useful analgesic adjuncts is a major barrier to the use of opioid-sparing multimodal analgesia in actual clinical care. This work aims to break down that barrier. Policymakers at the federal, state, and local levels are experimenting with countless ways to combat the opioid epidemic in the United States and to mitigate the high morbidity and mortality costs. This study assesses a novel strategy for the prevention of opioid abuse.
3. Eyeglasses-based green light therapy can be easily adopted for use most clinical care settings. Because of its potential for broad implementation, this therapy offers particular promise as an opioid sparing tool. By its nature, eyeglasses-based green light therapy need not displace any other pain treatment modality.

Therefore, it will not simply be one more opioid sparing strategy to be chosen among. Rather, it can be easily added to existing treatment regimes. Even modest effects on pain and individual opioid exposures would be massively magnified by the wide adoption this model has been designed to facilitate.

### 3. Approach

We will conduct a pilot trial testing the use of eyeglasses-based green light therapy as an analgesic adjunct to opioid therapy. The pilot trial is designed to accomplish both Specific Aims. The results of these aims will be information about trial feasibility and estimates of outcome measure values and treatment effects. These will enable the design of a definitive randomized controlled trial. It is not our expectation that the pilot trial will directly answer the question of green light therapy's clinical efficacy. Rather, it will be the first step in making that assessment and is essential to that continued progress.

### 3.1 Specific Aim 1

In this aim, we will use the pilot trial to test the feasibility of conducting a randomized controlled trial testing the use of eyeglasses-based green light therapy. We will do so by performing all elements of such a trial on a pilot scale. Throughout this process, we will assess the practicality of the study, monitor for unforeseen problems, and identify solutions to those problems (including alterations to trial design and conduct). The eyeglasses-based model of green light therapy, and this trial more broadly, has been designed to minimize interference with normal clinical care and to minimize treatment complexity. The intention is to maximize the ultimate usefulness of green light therapy: acceptance of and compliance with the therapy from both patients and providers is essential to achieving that usefulness. To that end, we will also collect feedback from participants regarding their subjective experiences, and we will invite comments from providers involved in the treatment of the participants. The overall goal of this aim, therefore, includes all aspects of feasibility and practicality: we recognize that this extends beyond simply the conduct of study activities.

### 3.1.1 Research Design

### Eyeglasses

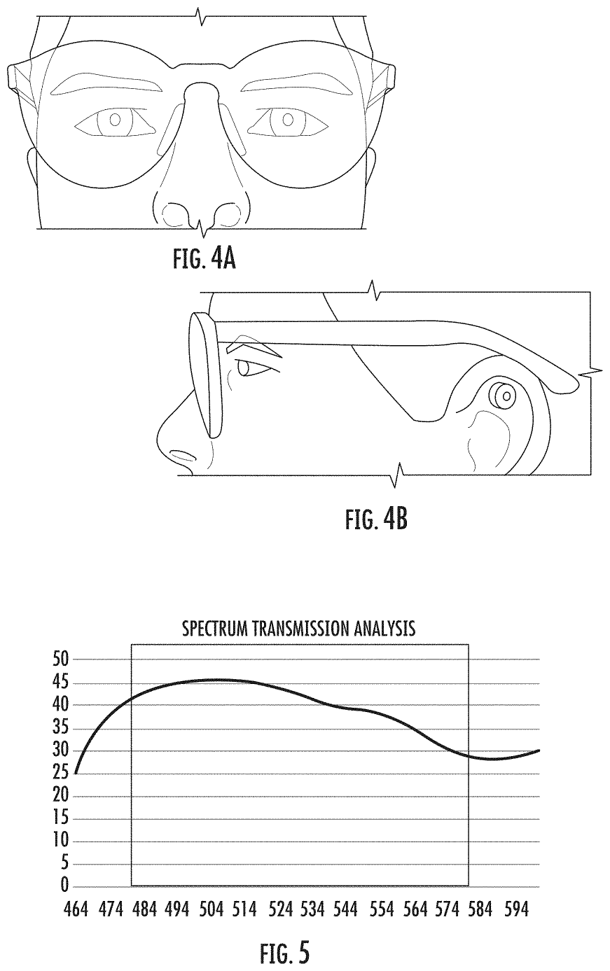

Thanks to recent fashion trends and the dramatic expansion of e-commerce enabling low-cost niche manufacturing, a wide array of eyeglasses in varying styles and colors are now easily available. To identify eyeglasses for use in this trial, we purchased several different examples from a major online retailer. We screened these eyeglasses for perceived lens color (as some eyeglasses relied on reflective coatings to appear green, but did not transmit perceptibly green light), fit (across various study personnel and colleagues), subjective build quality, aesthetic acceptability, and availability of matching clear-lensed versions for use as controls. The remaining eyeglasses were subjected to transmission spectroscopy across the 425 nm to 700 nm visual spectrum. On the basis of these spectra, the eyeglasses with the most green-biased transmission were chosen for use in this study (see, FIGS. 3 and 4).

### Participants and Enrollment

Two distinct patient populations will be included in order to test the effects of green light therapy in both acute pain and chronic pain conditions for which opioid therapy is common.

Thoracic surgery will be used as the acute pain condition. These patients typically have notable post-operative pain which resolves during recovery from surgery. In the post-operative period, the normal standard of care at our institution involves the use of opioid-based patient controlled analgesia (PCA). Therefore, opioid usage is controlled by the patient in response to their pain. Our PCA devices retain records of all patient commands for analgesia and all administration. This permits separate assessment of the quantity of opioid delivered and patient demand. These patients will be identified and enrolled in the study prior to their admission for surgery and will be provided eyeglasses for use during their post-operative inpatient stay.

Fibromyalgia will be used as the chronic pain condition. This is a relatively common chronic pain condition for which patients are typically followed on an outpatient basis. Opioids in this group are often prescribed on a variable ‘as-needed’ basis (PRN based upon pain intensity). As such, patient opioid use often varies with pain. We will obtain patient-reported opioid usage. These patients will be identified and enrolled in the study at their normal outpatient visits and will be provided eyeglasses for use for a 2-week period beginning on their enrollment.

In identifying and approaching all patients, the study team will coordinate with the primary clinical team. Consistent with no-cold-approach policies, a member of the primary clinical team known to the patient will make the initial approach to the eligible patient. If the eligible patient agrees to hear more about the study, a study team member will attend, explain the study in detail, and obtain written informed consent. Before study commencement, we will obtain all relevant Institutional Review Board approvals. Inclusion/exclusion criteria for the study will be:
1. Scheduled for thoracic surgery for which post-operative opioid PCA is anticipated (Acute Pain group) OR currently treated with opioid therapy for fibromyalgia (Chronic Pain group)
2. 18 years of age and older
3. Able to wear study eyeglasses for at least 4 hours per day
4. Agree to participate and provide written informed consent and HIPAA authorization

### Trial Procedures—Acute Pain group

Acute Pain group participants will be visited by study staff after their surgery upon their transfer to a floor unit (either normal care or step down; that is, after post-anesthesia care). Upon confirming their willingness participate, they will be randomized to receive either green or clear glasses. Participants will be asked to wear their study glasses for at least 4 hours per day throughout their hospital stay and will be provided log books in which to record their glasses-wearing duration each day and any commentary they wish to share. During this visit, participants will also complete the PROMIS-57 Profile. The Patient-Reported Outcomes Measurement Information System (PROMIS) is a collection of patient-reported measures developed by an initiative of the National Institutes of Health as high-quality, well-validated, and standardized patient-reported outcomes measures across multiple domains. The PROMIS-57 Profile is a detailed, standardized battery of PROMIS measures covering anxiety, depression, fatigue, pain intensity, pain interference, physical function, sleep disturbance, and ability to participate in social roles and activities.

On day of discharge, study staff will again visit participants to collect the study glasses. Participants will again complete the PROMIS-57 Profile. During participants' inpatient stays, study staff will continue to coordinate with the primary care teams to monitor for any issues arising from the study or the use of the study glasses. Providers will be supplied with contact information to provide any feedback they wish to share.

### Trial Procedures—Chronic Pain Group

Chronic Pain group participants will begin study procedures immediately following their enrollment. Participants will be randomized to receive either green or clear glasses and will complete the PROMIS-57 Profile. Participants will be asked to wear their study glasses for at least 4 hours per day for a period of 2 weeks. Unlike the Acute Pain group in which pain will typically self-resolve with operative healing and the hospital stay provides a convenient and applicable treatment timeline, the appropriate duration of green light therapy for use in chronic pain states is unknown. Preclinical findings suggest the onset of analgesic effects after 3 days. However, such timelines rarely translate directly to human populations. Most pharmacological analgesics achieve effect onset within minutes to hours, although the analgesic effects of antidepressants upon chronic pain states (which may also involve modulation of descending pain control mechanisms) can require a week or longer to manifest.

Here, we have chosen a moderate 2-week duration to allow for a range of times-to-onset. Participants will be provided log books in which to record their glasses-wearing duration, average pain, and opioid use each day. They will also be invited to include any commentary they wish to share.

Participants in this group will be provided with 2 additional copies of the PROMIS-57 Profile, which they will be asked to complete at the 1-week and 2-week timepoints. A stamped, addressed envelope will be provided for the return of the study materials after the 2-week study period. Study staff will follow up with participants' pain providers to obtain any relevant feedback.

### Sample Size Calculations

There are many methods and guidelines for determining sample sizes for pilot trials, and this is a topic of some contention. A compelling approach, and the one we adopt here, argues that pilot trials be powered specifically to detect unforeseen issues. In this method, one sets a detection level (the probability of the least-likely unforeseen issue one wishes to detect) and a confidence level (the probability of detecting that issue) and calculating the required sample n=ln(1−confidence)/ln(1−detection). Here, we calculate that a total enrollment of 60 participants will be sufficient to provide greater than 95% confidence in detecting issues with a 5% probability of occurrence. Divided evenly across Acute Pain and Chronic Pain groups (30 each) this sample will also provide approximately 80% confidence in detecting issues with a 5% probability of occurrence in only one group. This yields a 15 participant per condition (acute/chronic×green/clear) sample size. Interestingly, this chosen sample size also fulfills several other methods/guidelines for pilot trial sample sizes which range from 10 to 15 per condition.

These methods have generally sought to power pilot trials to produce usable estimates of outcome measure values. While the appropriateness of such an approach is debated, it does suggest that our chosen sample size will be satisfactory to produce such estimates.

### 3.1.2 Expected Outcomes

We have taken care to design the eyeglasses-based model of green light therapy to be simple to use and minimally-interfering. In choosing the model of eyeglasses to be used in this study, we have considered both transmission spectrum and usability. We expect this treatment to be broadly acceptable to both patients and providers. This trial will provide important feedback which can be used to further optimize treatment details. We are particularly interested to learn of participants' experiences using eyeglasses in this manner.

This pilot will also generate valuable information about the trial procedures. We have designed the trial to be straightforward to implement and conduct, for both study staff and participants. We expect the trial procedures will not be overly onerous and will have good compliance.

### 3.1.3 Potential Problems & Alternative Approaches

As a pilot trial, the one of proposed study's main purposes is to identify potential problems. As such, we fully expect to identify issues which we have not foreseen. We will be using this pilot trial to find and ameliorate those issues before proceeding to a definitive trial.

The largest potential problem we foresee is initial disbelief. Certainly, the concept of green light therapy elicits first reactions ranging from skepticism to hilarity (including for us). However, further reflection upon parallels with light-based effects on mood and affect and a review of the preclinical findings has generally proved sufficient to overcome initial reactions. Because of the ease of translating this therapy to clinical use, a cost/benefit consideration favors discovering whether green light therapy is efficacious in clinical care.

The chosen eyeglasses may be considered, by some, to be unacceptable. While aesthetics, fit, and subjective quality were selection criteria, such preferences are highly variable. Since we will not require participants wear the eyeglasses at all times, we do not anticipate that this will pose a compliance issue. We will monitor feedback regarding the eyeglasses. Since a large variety of different eyeglasses are easily available, we could potentially offer additional eyeglass models. We would prefer, however, to minimize unnecessary confounding factors.

### 3.2 Specific Aim 2

In this aim, we will use outcomes data collected from the pilot trial to generate estimates of the value and distribution of those outcome measures in the specific populations being studied. We will also generate estimates of treatment effect sizes in these populations. Together, these estimates will be essential for the design of the definitive randomized controlled trial which we intend to test the efficacy of this green light therapy. It is important to collect these outcomes data as part of the pilot trial because some of the measures (particularly the patient-reported outcomes) exceed those collected as a normal part of clinical care.

### 3.2.1 Research Design and Expected Outcomes

Trial procedures are described under Specific Aim 1. There are, broadly, 4 outcome measures of interest: 1. Opioid use, 2. Pain intensity, 3. PROMIS measures, and 4. Eyeglasses usage time. For Acute Pain group participants, opioid use and pain intensities will be obtained from electronic health records because these data are collected as a normal part of clinical care. For Chronic Pain group participants, opioid use and pain intensities will be collected from daily self-reports. Both groups will complete the PROMIS measures and report eyeglasses usage. Our intention for the definitive trial is that the primary outcome will be opioid use with secondary outcomes of pain intensity and PROMIS measures, and with eyeglasses usage as a control term along with standard demographic and clinical variables. Opioid use will be summated across the post-operative inpatient period for Acute Pain group participants and across each week of treatment for Chronic Pain group participants. This reflects our focus on opioid exposures as they cumulatively pertain to abuse risk and aligns the timeframes of opioid use measures and PROMIS measures. Because of patients' ability to vary their opioid usage as their pain requires, we do not expect green light therapy to have a detectable effect on pain intensities (presuming that opioid effects on pain intensity will predominate). However, we will still assess the distribution of reported pain intensities over the same reporting periods in case such effects are present. The PROMIS-57 Profile yields disaggregated scores for each of the tested domains calibrated against the general population or the calibration sample population (depending on domain). We are particularly interested in the change in domain scores over the study reporting periods. We will use data from the pilot trial to estimate values and distributions for these outcome measures in our study populations. Such estimates will be essential for the design of the definitive trial.

### 3.2.2 Potential Problems & Alternative Approaches

Data sourced from electronic health records will be straightforward to obtain. However, data sourced from patient self-reports may be incomplete. We have attempted to minimize the amount of self-report data required in order to minimize the burden on participants. Additionally, study staff will provide in-person or telephone follow up reminders to participants to complete PROMIS measures and to submit completed logs upon completion of the study period (for which we will also provide stamped, addressed envelopes). We have considered online, REDCap-based reporting tools for these data but decided that physical notebook logs are likely to have higher compliance. We remain open to revisiting this decision should results or participant feedback warrant.

It is possible that some of the measures will generate highly variable data. Opioid usage and pain intensity data can often show considerable variability between individuals due to underlying neurobiology (e.g. opioid tolerance) and the subjective and variable nature of pain perception. If found, such variability would likely be reflective of variability in the overall populations rather than merely a sample size effect. In this case, it may be necessary to consider data transformations (e.g. logarithmic transformations of opioid usage) or normalizations (e.g. changes in pain intensity from same-patient baseline).

### 4. Future Directions

We expect to use the experience and data obtained from this pilot trial in the design of a definitive randomized clinical trial which will fully test the efficacy of this eyeglasses-based green light therapy as an opioid-sparing analgesic adjunct. We anticipate that a role in multimodal analgesia will be the most impactful use for green light therapy. However, truly broad adoption in that role would likely require testing in conditions beyond those included here.

The neurobiological basis of the green light analgesic effect remains only lightly explored. While modulations of descending pain control mechanisms are likely involved, an exploration of how visual perception mediates such changes would be fascinating and may uncover exciting therapeutic targets.

### Example 2: Green Light Based Analgesia—Novel Non-Pharmacological Approach to Fibromyalgia Pain: a Pilot Study

### Introduction

More than 50 million adults in America suffer from chronic pain, per the Centers for Disease Control and Prevention (CDC), with nearly 20 million of those experiencing high-impact pain which is defined as pain that severely impacts quality of life and limits activities. There continues to be significant reliance on pharmacological modalities for the management of chronic pain, with a particular focus on opioid analgesics as a singular option for pain management. This is a leading cause of the prescription opioid epidemic, which has had devastating impacts on our population. Fibromyalgia is a prototypical central pain disorder, which is often used as a model to study chronic pain disorders. It has an estimated prevalence of approximately 1.1% to 5.4% in the general population. The widespread use of opioids in patients with fibromyalgia has been well demonstrated in several health claims database studies, with rates of use ranging from 11.3% to 69%. The continued large scale use of opioids in this population persists in spite of evidence suggesting lack efficacy and concern for side effects.

Minimizing opioid exposures reduces misuse risk, but requires adequate opioid-sparing multimodal analgesic strategies, particularly non-opioid analgesic adjuncts, to ensure effective treatment of pain, particularly high impact pain. In practice, however, this manifests as polypharmacy. Non-opioid medications commonly hold their own abuse potential and side effect profile, which may limit their use. Non-pharmacologic options would be an ideal approach. While behavioral therapy and other non-pharmacological strategies have long been shown to offer benefit in patients with fibromyalgia, these continue to be limited in use or difficult to integrate into routine self-care. A broadly effective and easily implemented non-pharmacological analgesic approach would be of considerable value. In the search of such a modality, a novel approach that is gaining in popularity is the manipulation of the visual light spectrum to provide pain relief.

Concentrated exposure to the visual light spectrum can be obtained by filtering specific wavelengths in or out, resulting in desired narrow spectrum exposure to patients. Use of different light spectra has been shown to help with mood or emotional disorders, and to also have physiologic impacts. Exploration of blue light phototherapy to treat chronic plaque psoriasis by dermatologists has shown positive potential. Further, it is now common for people to wear glasses or contact lenses with blue light filters when looking at computer screens for extended periods of time in attempts to alleviate symptoms of headache, fatigue, and dry eyes among others. This is conceptually similar to bright light therapy, which has proven effective in the clinical treatment of mood and affect disorders such as depression or seasonal affective disorder.

The relationship between visualized light and pain perception has been studied for over a decade. Leichtfried et al reported improvement in both pain and depression in patients with chronic nonspecific back pain after treatment with bright light therapy versus dim or no light therapy. This study was conducted in patients suffering from both depression and back pain, and demonstrated a greater effect on depressive symptoms than on pain. Similarly, Noseda et al examined differences in colored light exposure for migraine photophobia, and found green light resulted in reduced severity and exacerbations of migraines.

Green light has also been studied in other non-visual responses. Exposure to green light of the cone photoreceptors in the eye, alters melatonin production to stimulate energy and alertness and results in resetting the circadian rhythm as an example of non-visual response. Green light also alters serotonin levels and stimulates the endogenous opioid system with an increase in enkephalins. Cleymaet et al have recently elaborated on the relationship between endogenous opioid signaling and exposure to green light.

Ibrahim et al, in preclinical studies, have shown that green light elicits a strong antinociceptive response in rats. They proposed the antinociceptive effects of green light were from reversal of tactile and thermal hypersensitivity, while the anti-allodynic and hyperalgesic effects were due to decreased calcium influx via the N-type calcium channel. The rats who were fitted with green contacts that permit light transmission in the green part of the visual spectrum, developed antinociception when exposed to ambient light. The antinociceptive effect involved the (1) visual system, (2) mu-opioid receptor pathways and descending pain inhibitory pathways from the rostral ventromedial medulla (RVM), (3) increased spinal cord expression of enkephalins implicating the endogenous opioid system, and (4) alterations in spinal cord and nociceptor proteomes. The effect of green light on the endogenous opioid system appears to play a key role in antinociception, anti-allodynia and anti-hyperalgesia. They demonstrated green light phototherapy's ability to reverse reduced sensory thresholds in a model of neuropathic pain, supporting its use as a possible novel, non-pharmacological approach in managing chronic pain.

The antinociceptive effects of green light therapy also involves the modulation of descending pain control mechanisms, which results in changes in the signaling and proteomes at the spinal cord level. These findings make a strong case for visualized green light alterations in pain processing both centrally and peripherally. Noseda et al, in their study on the beneficial effects of green light therapy on migraines, postulated that photic signals that originate in intrinsically photosensitive retinal ganglion cells containing melanopsin converge on thalamic trigeminovascular neurons believed to relay nociceptive signals from the dura to the cortex.

In order to explore the use of green light in pain conditions further, we conducted an NIH funded trial, evaluating the impact of green light on pain, opioid use, and anxiety in patients with fibromyalgia. We chose fibromyalgia as our study population given that it is a disordered sensory processing condition, it may be particularly amenable to the beneficial effects of green light therapy. Most studies have evaluated exposure to LED lights as a mode of green light delivery; our study used green-light filtering eyeglasses, which would allow the wearer to move about with minimal interference.

### Methods

After obtaining IRB approval (IRB 102106), we recruited and randomized adult patients with a known diagnosis of fibromyalgia at Duke University Health System taking opioids from August 2019 through December 2020 (17 months, including a 3-month COVID suspension). Primary exclusion criteria was colorblindness according to the Ishihara Colorblindness Test.

We examined multiple commercially available green light filtering eyeglasses. The eyeglasses were subjected to transmission spectroscopy across the 425-nm to 700-nm visual light spectrum. We found commercially available eyeglasses even from the same manufacturer and same model had varying green light transmission for different lots. For purposes of our study we found 1 lot of commercially produced green sunglasses that provided peak transmission of green light in the wavelength band we had found from our pilot studies to be most effective for pain relief. The eyeglasses had peak green light transmission between 500 nm and 515 nm (the green light spectrum range is 480 nm-580 nm) (FIG. 5). For purposes of patient care and for future studies we will be using specially manufactured eyeglasses with peak transmission in this wavelength band to ensure accuracy and efficacy.

We recruited and randomized patients to 1 of 3 arms: clear eyeglasses (control), green eyeglasses, or blue eyeglasses. The blue eyeglasses were included as a second intervention of colored light, and allowed us to evaluate the impact of colored light versus clear light, and to determine the extent to which the effects observed in any group were unique to a specific color. Patients were instructed to wear their study glasses for at least 4 hours per day for 2 weeks, while awake. Patients completed the PROMIS-57 Profile just before randomization (baseline) and again at 1 and 2 weeks. The PROMIS-57 Profile is a detailed, standardized battery of PROMIS measures covering anxiety, depression, fatigue, pain intensity, pain interference, physical function, sleep disturbance, and ability to participate in social roles and activities. Daily opioid use (documented in oral morphine equivalents [OME]) and pain scores were recorded for each patient at baseline, week 1, and week 2. Patients also recorded the times they wore their eyeglasses each day to ensure compliance.

Patient demographics were also collected, and the 2 experimental groups (green and blue) were compared to the control group (clear).

The primary outcome for this study was the reduction of opioid use after 2 weeks of intervention. Reduction of opioid use was determined by a binary outcome due to a high prevalence of no change in opioid use. The clinically significant reduction was determined to be 10% reduction in opioid use at 2 weeks of intervention. Current guidelines for active opioid taper aim to reduce opioid dose by 10-20% every week. Therefore 10% dose reduction in 2 weeks without active tapering is considered significant. Secondary outcomes include reduction of patient reported pain scores and decreased patient reported anxiety. Pain scores were evaluated on a numerical scale (0-10) and anxiety was reported as part of the PROMIS 57 survey.

### Statistical Analysis

Patient and surgical characteristics were described by treatment group via means (SD) or median [Q1, Q3] for numeric variables and count (%) for categorical variables. The groups will be compared overall and to the control group via appropriate parametric or non-parametric tests. If numeric factors failed the Shapiro-Wilks normality test, non-parametric tests (Wilcoxon Rank sum or Kruskal-Wallis) were used, and if a categorical factor had low expected cell counts Fisher exact tests was used.

The primary outcome of change in OME consumption was analyzed both as a numeric and binary variable. The comparison of numeric change in OME consumption between treatment groups was performed with a non-parametric Wilcoxon rank sum test, and the binary outcome of a greater than 10% decrease in OME consumption was analyzed via chi-square test and logistic regression. For the secondary outcomes of pain and PROMIS score changes we compared groups using Wilcoxon Rank sum tests and linear regression analysis.

Study sample size was based on the Viechtbauer et al. method for detection of adverse events in pilot studies. Based on the formula in the paper, a study of 45 Chronic Pain patients will provide approximately 80% confidence in detecting issues with a 5% probability of occurrence. Hence we enrolled and randomized a minimum of 15 participants per treatment group.

### Results

We initially recruited 45 patients and randomly assigned 15 patients per group. Of these only 30 (67%) completed the study, with the highest loss to follow-up rate in the clear glasses control group (20% in green, 33% in blue, and 47% in the clear glasses group). Patient retention was impacted significantly by COVID in the earlier part of the year, and reports of headaches in the blue and clear glasses groups lead to patient withdrawal (1 blue, 2 clear). Given the high rate of attrition in the clear glasses control group, we enrolled an additional 4 patients to treat with clear glasses, all of whom completed the study, to provide sufficient control subjects for comparison.

There were a total of 9 adverse events among the 49 enrolled patients (2 Blue, 6 Clear, 1 Green, p=0.15), and 3 patients withdrew due to adverse events. Eight out of the 9 events were headaches and one patient was hospitalized for a non-study related event. Seven of the headaches were considered study related; none of which were considered severe. The one headache that was not considered study related was in the green group. Our analysis cohort consisted of 34, of which 31 patients identified as female and the other 3 male, with an average age of 57 ±10. Patient baseline factors were similar across the three groups (Table 2).

TABLE 2

| | Blue (N =10) | Clear (N =12) | Green (N =12) | p value |
|---|---|---|---|---|
| Race | | | | 0.418¹ |
| White or Caucasian | 7 (70.0%) | 7 (58.3%) | 5 (41.7%) | |
| Black or African American | 3 (30.0%) | 4 (33.3%) | 4 (33.3%) | |
| More than one race | 0 (0.0%) | 1 (8.3%) | 3 (25.0%) | |
| Age | 53.0 [46.0, 64.0] | 58.0 [51.0, 67.0] | 57.5 [51.5. 64.0] | 0.773² |
| Gender (Female) | 9 (90.0%) | 10 (83.3%) | 12 (100.0%) | 0.351¹ |
| OME at Consent | 51.3 [16.0, 80.0] | 55.0 [17.5, 81.2] | 37.5 [25.0, 74.0] | 0.938² |
| BL Pain Score | 8.0 [7, 8] | 7.0 [5.5, 8] | 7.0 [6, 8] | 0.457² |
| BL PROMIS | | | | |
| Physical function | 4.5 [3, 5] | 4.0 [3, 4] | 3.5 [3, 4.5] | 0.649² |
| anxiety | 18.5 [14, 24] | 19.5 [14, 21.5] | 22.0 [18, 28] | 0.236² |
| depression | 14.0 [10, 22] | 14.5 [10.5, 19.5] | 15.0 [11, 22.5] | 0.818² |
| fatigue | 32.0 [28, 35] | 30.5 [26.5, 35.5] | 32.0 [28.5, 37.5] | 0.632² |
| sleep | 27.0 [22, 31] | 26.0 [22.5, 33] | 30.0 [24.5, 38.5] | 0.356² |
| activities | 19.5 [15, 24] | 19.0 [15, 25] | 17.0 [8, 24] | 0.561² |
| pain | 31.5 [30, 37] | 32.0 [28.5, 34] | 32.5 [26.5, 39.5] | 0.822² |

¹Chi-Square
²Kruskal Wallis *missing for 1 clear glasses patient

For our primary outcome, we found no difference in the 2-week numeric change in opioid dose between the treatment groups, and in all three groups the median change was 0 units (p=0.60). Further the blue and clear groups' upper and lower quartiles were also found to be zero change. The green group lower quartile change in median OME was a decreased on 17.5 and the upper quartile change was zero.

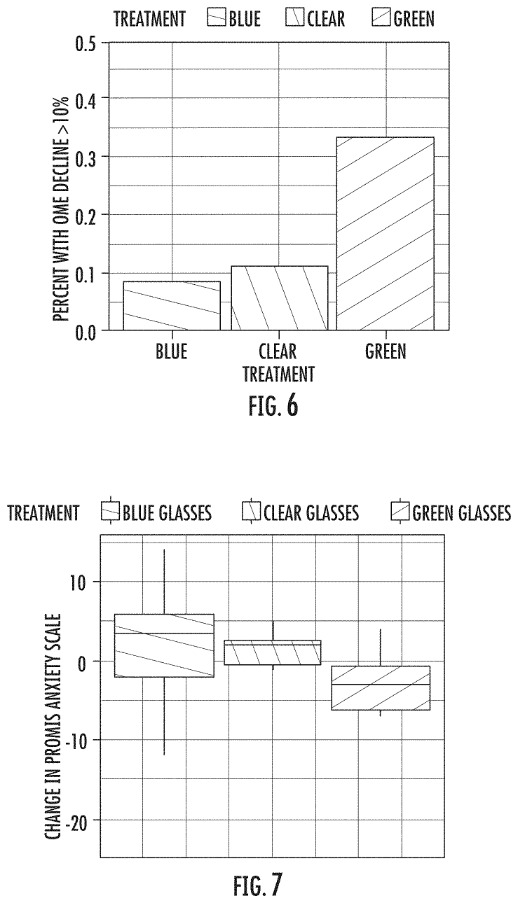

To evaluate clinical significance, we determined the rate of a 10% or greater decline in OME in and found that 33%, 11%, and 8% of the green, blue, and clear eyeglass groups, respectively achieved this clinically meaningful outcome (p=0.23, FIG. 6). A logistic regression analysis indicated a trend toward difference between green and clear eyeglass groups, with the odds of achieving a 10% or greater decline in OME for the green group estimated to be 5.5 times higher than that for the clear group (95% CI [0.66, 119]; p=0.109). There was no evidence of a difference for the blue group compared to the clear group (OR [95% CI] 1.38 [0.05, 38.41]; p=0.662). The trending difference in a 10% or greater decline in OME between green and clear groups remained when we further adjusted for age.

For our secondary outcome of pain intensity score change, we observed median [Q1, Q3] values of −0.5 [−1, 0] in the blue group, 0 [−1, 0] in the clear group, and −1 [−1, 0] in the green group, which corresponded to a p-value of 0.62. A linear regression analysis for pain score change estimated mean difference (95% CI) of −0.10 (−1.25, 1.06) for the green and clear groups (p=0.86), and 0.22 (−1.0, 1.4) for the blue and clear groups (p=0.71).

For another of our secondary outcomes, the PROMIS scores, we observed a promising signal in the anxiety domain. The observed change in anxiety scores found the only group with a decline was the green group (medians of −3, 3.5, and 2 in the green, blue, and clear groups, respectively (p=0.11)), and a significant difference on the fear question in particular (p=0.03). After performing a linear regression analysis for change in anxiety domain score, the decline in anxiety score for the green group was estimated to be 4.2 points greater than that for the clear group (95% CI [−9.8, 1.4]; p=0.138), FIG. 7. The trending difference in anxiety scores between green and clear groups remains when we further adjusted for age or compliance. There was no evidence of a difference between the anxiety domain scores for the blue group compared to the clear group (mean difference [95% CI] 1.5 [−4.3, 7.4]; p=0.601).

### Discussion

The ability to reduce opioid use in the chronic pain population without increasing reported pain would have immense impact on managing this pain. This study demonstrated that the odds of achieving a 10% or greater reduction in daily opioid requirements was 5.5 times higher in patients who wore green light filtering eyeglasses compared to clear light filtering eyeglasses (95% CI [0.66, 119]; p=0.109). Both pain intensity and pain interference did not increase in spite of the reduction in opioid use. By reducing the daily opioid requirement, with sustained pain scores (rather than increased), reduces many risks for this population.

### Exposure to Green Light Based Analgesia Reduces Opioid Requirements

The complex pain experience of those suffering from fibromyalgia results in chronic use of pain medications, of which opioids are a part. In fact, over 60% of patients diagnosed with fibromyalgia are prescribed long-term opioids. Further, fibromyalgia is diagnosed predominately in women, and opioid medications are prescribed to women considerably more often than men. These compounding factors create a population of patients who are at high risk for opioid side effects and misuse. This risk can be minimized by decreasing opioid exposure, which can only be accomplished with a balanced multimodal approach to their pain management. The use of multimodal therapy, which includes the use of opioids, opioid-sparing medications, and non-pharmacological therapies, is essential for successful treatment of pain. Pharmacological options for pain management have narrow therapeutic benefit and significant side effects and risks.

Recent clinical studies, including our own, support the findings of the preclinical studies described above, which demonstrate the beneficial effects of green light based analgesia for chronic pain management. Martin et al, in a one way crossover clinical trial in fibromyalgia patients reported a 60% reduction in pain and an almost 50% reduction in daily morphine milligram equivalent use. A study evaluating headache frequency and quality of life in migraine patients exposed to green light has shown that patients saw their baseline pain scores (8-10) prior to green light exposure, reduce to 2.8. These patients also demonstrated over 40% reduction in opioid use.

### Green Light Therapy Improves Patient Reported Measures of Anxiety and Pain

Psychological comorbidities often coexist in chronic pain conditions, like fibromyalgia, such as anxiety which is reported in up to 85% of fibromyalgia patients. Anxiety, especially fear-based anxiety, has been linked to higher opioid use. Colananti et al have demonstrated these effects in both animal and human models, where endogenous opioids, particularly enkephalins, are stimulated to mitigate anxiety and fear.

Krebs et al, in the SPACE randomized clinical trial involving 240 patients with osteoarthritis pain or chronic back pain found no difference in pain related function in patients treated with opioids compared to non-opioid medications. While they also found most other health related quality of life measures did not differ between the 2 groups, only anxiety symptoms were statistically better in the opioid group. These findings were consistent with Sullivan et al, on the role of the endogenous opioid system, particularly enkephalins in stress and emotional suffering, resulting in the increased use of opioids due to underlying anxiety.

Pain shares similar biological mechanisms with anxiety. Anxiety is an important mediator in the cognitive constructs of catastrophizing, hypervigilance and fear avoidance in the exacerbation of pain experiences. Anxiety has been implicated in the development of persistent pain states, especially during the postoperative period. Henry et al describe evidence supporting the role of enkephalins in anxiety states and stress induced analgesia.

Opioids are implicated in acute modulation of anxiety and anxiety-related brain response. In addition to pain relief, opioid benefits may relate to off-target effects such as anxiety. For example, anxiety improved over 12-months in chronic pain patients randomized to opioid therapy. Randomization to opioid therapy, in patients with low back pain and osteoarthritis, produces long-term (12-month) improvements in self-reported anxiety. Acute administration of opioids can acutely reduce anxiety and anxiety response in the amygdala. For example, reduced anxiety response in the amygdala and reduced self-reported anxiety occur after a single dose of heroin, an opioid agonist.

Many patients taking opioids for chronic pain are reluctant to decrease their regimen due to the fear of severe pain, and this fear-based anxiety can lead to the escalation of opioid use. In the chronic pain population, this anxiety may be elated by the opioid these patients take for their pain syndrome. In order to successfully decrease or eliminate opioid use in these patients, their anxiety must also be addressed. As noted above, a pharmacological regimen may cause adverse effects or drug interactions which may cause harm to patients. Non-pharmacological interventions, especially one that also manages pain, would be ideal. Exposure to green light has been shown to increase enkephalin levels in spinal cord tissue samples after the therapy, supporting its feasibility as a anxiolytic. Our results demonstrated decreased anxiety in patients receiving green light therapy, most notably in the fear based anxiety. The decline in anxiety score for the green group was estimated to be 4.2 points greater than that for the clear group (95% CI [−9.8, 1.4]; p=0.138). This further supports the use of green light in decreasing anxiety, particularly fear-based anxiety, which may have contributed to the observed decrease in opioid use.

The results of our study yielded other of key findings. First, the blue eyeglass group had similar or worse results compared to the clear group for all outcomes, suggesting that the next phase of the study should focus on contrasting green and clear eyeglasses alone. Any benefit from the green group can be considered a benefit of wavelengths of light within the green spectrum, rather than total spectrum (clear) light.

Second, certain patient groups may not be appropriate for treatment with light (i.e., those with a history of headaches). We did not see any study related adverse events in the green glasses group, suggesting the intervention is safe for this population. Further investigation should exclude patients with a preexisting diagnosis of headaches or migraines to ensure safety of participants within the control group.

Third, during our 2-week follow-up window, many patients had no change in their OME or pain levels, indicating that a longer follow-up window and treatment exposure may be required to observe a difference in outcomes of interest.

### Conclusions

Our study demonstrated the feasibility of this treatment approach and study design, and supports a future study to determine the efficacy of green light based analgesia on opioid use, pain and anxiety. While the reduction of opioid use was not of statistical significance, we believe it to be on clinical significance as there was no increase of patient reported pain. This warrants further investigation in a large-scale trial of the use of green-light filtration of ambient light to mitigate opioid use and possible mediation of psychological impacts of pain with the use of green-lensed eyeglasses.

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

The foregoing is illustrative of the present invention and is not to be construed as limiting thereof. Although a few example embodiments of this invention have been described, those skilled in the art will readily appreciate that many modifications are possible in the example embodiments without materially departing from the teachings and advantages of this invention. Accordingly, all such modifications are intended to be included within the scope of this invention as defined in the claims. The invention is defined by the following claims, with equivalents of the claims to be included therein.

What is claimed is:

1. A method of treatment of pain experienced by a subject, the method comprising:
filtering ambient light to expose the subject to a green-biased light spectrum having a peak transmission between 500 and 515 nm; and
reducing pain in the subject in response to the filtering step.

2. The method of claim 1 wherein the green-biased light spectrum has a peak transmission between 502 and 506 nm.

3. The method of claim 2 wherein the peak transmission is 40% or greater.

4. The method of claim 1 wherein the green-biased light spectrum has a peak transmission between 502 and 504 nm.

5. The method of claim 1 wherein the green-biased light spectrum comprises at least 25% transmission at each end wavelength in the green light wavelength band.

6. The method of claim 1 wherein the pain is caused by fibromyalgia. The method of claim 1 wherein the pain is caused by thoracic surgery.

8. The method of claim 1 wherein the filtering step is carried out using eyeglasses worn by the subject.

9. The method of claim 8 further comprising wearing the eyeglasses for at least four hours per day for at least two consecutive weeks.

10. The method of claim 1 further comprising reducing anxiety in the subject in response to the filtering step.

11. A device for treatment of pain experienced by a subject, the device comprising:
at least one lens configured to filter ambient light to expose the subject to a green-biased light spectrum having a peak transmission between 500 and 515 nm.

12. The device of claim 11 wherein the green-biased light spectrum has a peak transmission between 502 and 506 nm.

13. The device of claim 11 wherein the peak transmission is 40% or greater.

14. The device of claim 11 wherein the green-biased light spectrum has a peak transmission between 502 and 504 nm.

15. The device of claim 11 wherein the green-biased light spectrum comprises at least 25% transmission at each end wavelength in the green light wavelength band.

16. The device of claim 11 wherein the device comprises:
a frame holding the at least one lens and configured to be worn over the ears and nose of the subject such that the at least one lens is positioned in front of the eyes of the subject;
a first extension extending rearwardly from a first edge of the at least one lens and configured to extend toward a first ear of the subject; and
a second extension extending rearwardly from a second opposite edge of the at least one lens and configured to extend toward a second ear of the subject,
wherein the first and second extensions are configured to block ambient light from reaching the eyes of the subject.

17. The device of claim 16 wherein the first and second extensions are also configured to filter ambient light to expose the subject to a green-biased light spectrum having a peak transmission between 500 and 515 nm.
